(19) United States
(12) Patent Application Publication
(10) Pub. No.: US 2024/0182114 A1
(43) Pub. Date: Jun. 6, 2024

(54) VEHICLE STRUCTURE

(71) Applicant: MITSUBISHI JIDOSHA KOGYO KABUSHIKI KAISHA, Tokyo (JP)

(72) Inventors: Yasuo AKIMOTO, Tokyo (JP); Wataru SUEHIRO, Tokyo (JP); Norifumi YAMAMOTO, Tokyo (JP); Hironori NAKA, Tokyo (JP); Hikaru TACHI, Tokyo (JP)

(73) Assignee: MITSUBISHI JIDOSHA KOGYO KABUSHIKI KAISHA, Tokyo (JP)

(21) Appl. No.: 18/285,187

(22) PCT Filed: Feb. 1, 2022
(86) PCT No.: PCT/JP2022/003904

§ 371 Date: Sep. 29, 2023

(30) Foreign Application Priority Data
Mar. 30, 2021 (JP) 2021-056536

(51) Int. Cl. B62D 21/02; B62D 21/11

(52) U.S. Cl. CPC B62D 21/02; B62D 21/11

(57) ABSTRACT

A vehicle structure includes: a pair of side frames disposed apart in a vehicle width direction and extending in a vehicle front-rear direction; and a cross member extending in the vehicle width direction, and penetrating the pair of side frames and connecting the pair of side frames. The cross member is formed of a pipe having a substantially square cross section with a corner portion curved in an arc shape. A corner portion of the cross member at a vehicle lower side is set to have a curvature radius larger than a curvature radius of a corner portion at a vehicle upper side.

### TECHNICAL FIELD

The present invention relates to a vehicle structure in a frame vehicle.

### BACKGROUND ART

In a frame vehicle supporting a cab body or a cargo box by a chassis frame, the chassis frame includes a pair of side frames and a plurality of cross members connecting the pair of side frames.

Patent Literature 1 discloses a vehicle structure in which both end portions of a cross member formed of a pipe having a circular cross section are connected through a pair of side frames in such a frame vehicle.

In order to increase torsional rigidity of a chassis frame in such a vehicle structure, a diameter of the cross member may be secured to be large and a cross-sectional area may be increased.

### CITATION LIST

### Patent Literature

Patent Literature 1: JP2007-533526A

### SUMMARY OF INVENTION

### Technical Problem

However, the diameter of the cross member is restricted by a dimension of a side frame in an upper-lower direction, and in addition, a space to be secured between the cross member and a vehicle-mounted component disposed around the cross member has to be considered, and there is a limit to increasing the diameter of the cross member.

Therefore, a pipe having a square cross section as the cross member may be used.

That is, if diameters are the same, since a cross-sectional area of the square pipe is larger than that of the circular pipe, when a pipe having a square cross section is used as the cross member, it is possible to increase a cross-sectional area of the cross member while preventing an increase in the diameter.

However, when a pipe having a square cross section is used as the cross member, a load in a direction of pushing up from a lower side to an upper side via a suspension device is applied to the side frame, so that the load tends to concentrate particularly on a lower corner portion of rectangular corner portions of the cross member at joint portions between the cross member and the pair of side frames, and durability may decrease.

The present invention has been made in view of the above circumstances, and an object of the present invention is to provide a vehicle body structure which is advantageous in securing both torsional rigidity and durability of joint portions between a cross member and a pair of side frames.

### Solution to Problem

In order to achieve the above object, one aspect of the present invention includes: a pair of side frames disposed apart in a vehicle width direction and extending in a vehicle front-rear direction; and a cross member extending in the vehicle width direction, and penetrating the pair of side frames and connecting the pair of side frames, in which the cross member is formed of a pipe having a substantially square cross section with a corner portion curved in an arc shape, and a corner portion of the cross member at a vehicle lower side is set to have a curvature radius larger than a curvature radius of a corner portion at a vehicle upper side.

In one aspect of the present invention, the pair of side frames have kick-up portions inclined toward one side in an upper-lower direction as the kick-up portions extend toward one side in the vehicle front-rear direction, and the cross member connects the kick-up portions of the pair of side frames.

In one aspect of the present invention, a suspension device is provided at lower portions of the pair of side frames, and the cross member is positioned within a range in which the suspension device is positioned in the vehicle front-rear direction in a plan view.

In one aspect of the present invention, a load input portion from the suspension device to each of the side frames is deviated outward in the vehicle width direction relative to a center of a width of the side frame in the vehicle width direction.

In one aspect of the present invention, brackets are provided at positions of the side frames above the cross member.

In one aspect of the present invention, a drain hole is formed in a lower surface of the cross member.

In one aspect of the present invention, a cable of an in-vehicle equipment is fixed to an upper surface of the cross member.

### Advantageous Effects of Invention

According to one aspect of the present invention, since the cross member connecting the pair of side frames is formed by the pipe having the substantially square cross section with the corner portion curved in an arc shape, it is possible to secure a large cross-sectional area while preventing an increase in a diameter of the cross member, which is advantageous in improving torsional rigidity of the cross member without securing a large occupied space.

Since the corner portion of the cross member at the vehicle lower side is set to have the curvature radius larger than that of the corner portion at the vehicle upper side, when a load input to the side frame so as to push upward from below is applied to a joint portion between the side frame and the cross member, it is possible to prevent the load from concentrating on the corner portion of the cross member at the vehicle lower side, which is advantageous in securing durability of joint portions between the cross member and the pair of side frames.

According to one aspect of the present invention, when the cross member is connected to the kick-up portions, it is possible to secure a large dimension in the upper-lower direction between the corner portion where the curvature radius of the cross member at the vehicle lower side is set to be large and a lower side ridgeline of a respective one of the kick-up portions having high rigidity, so that it is advantageous in preventing concentration of a load applied to the corner portion of the cross member at the vehicle lower side from the lower side ridgeline having high rigidity, and it is more advantageous in securing durability of the joint portions between the cross member and the pair of side frames.

According to one aspect of the present invention, even when large loads are input from the suspension device to the joint portions between the cross member and the pair of side frames, since the corner portion of the cross member at the vehicle lower side is set to have the curvature radius larger than that of the corner portion at the vehicle upper side, it is advantageous in securing durability of the joint portions between the cross member and the pair of side frames.

According to one aspect of the present invention, even in a case where a lower portion of the side frame is twisted outward in the vehicle width direction and a load is intensively applied to the corner portion of the cross member at the vehicle lower side, since the corner portion of the cross member at the vehicle lower side is set to have the curvature radius larger than that of the corner portion at the vehicle upper side, it is advantageous in securing durability of the joint portions between the cross member and the pair of side frames.

According to one aspect of the present invention, since a periphery of an upper portion of a respective one of the joint portions between the cross member and the side frames is reinforced by a respective one of the brackets provided at the positions of the side frames above the cross member, even when a load concentrates on the corner portion of the cross member at the vehicle upper side, it is advantageous in securing durability of the joint portions between the cross member and the pair of side frames.

According to one aspect of the present invention, since water, mud, or the like entering an inside of the cross member is easily guided to the drain hole along the arc shape of the corner portion of the cross member at the vehicle lower side, it is advantageous in smoothly discharging water, mud, or the like downward.

According to one aspect of the present invention, since a large area of the upper surface of the cross member can be secured, the cable of the in-vehicle equipment can be directly attached to the upper surface without adding a dedicated component, which is advantageous in reducing the number of components and cost of the components.

### BRIEF DESCRIPTION OF DRAWINGS

FIG. 1 is a perspective view showing a configuration of a vehicle to which a vehicle structure according to an embodiment is applied.

FIG. 2 is a side view of a suspension device and a joint part between a fourth cross member and a side frame as viewed from an outside in a vehicle width direction.

FIG. 3 is a side view of a joint part between a rear portion of a fuel tank and the fourth cross member and the side frame, as viewed from an inside in the vehicle width direction.

FIG. 4 is a plan view of the joint part between the fourth cross member and the side frame as viewed from above the vehicle.

FIG. 5 is a bottom view of the suspension device and the joint part between the fourth cross member and the side frame as viewed from below the vehicle.

### DESCRIPTION OF EMBODIMENTS

Hereinafter, a vehicle structure according to an embodiment of the present invention will be described with reference to the drawings.

In the following drawings, reference sign FR denotes a vehicle front side, reference sign UP denotes a vehicle upper side, and reference sign HL denotes a vehicle width direction.

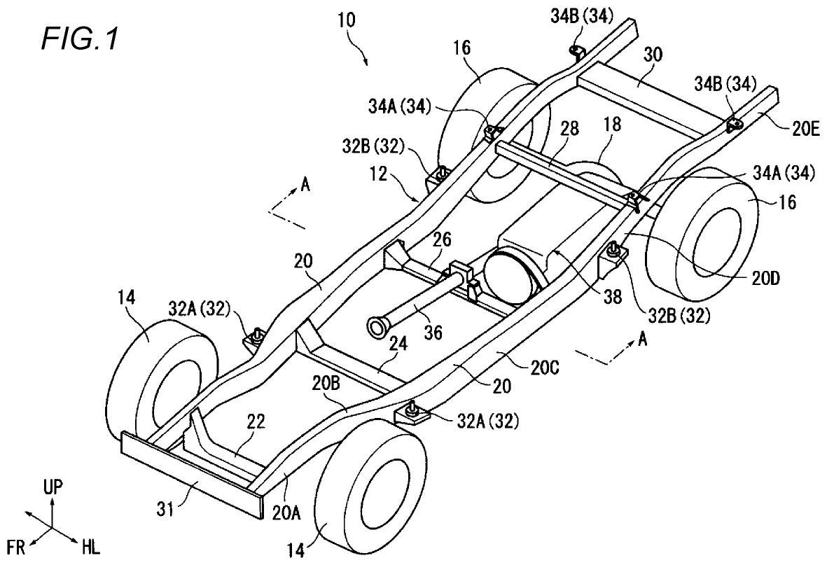

As shown in FIG. 1, in the embodiment of the present invention, a case where a vehicle 10 is a frame vehicle 10 in which a cab body (not shown) including a vehicle compartment in which an occupant rides as a vehicle body component is supported by a chassis frame 12 will be described.

In the present embodiment, the frame vehicle 10 is a pickup truck which serves as the vehicle body component and in which the cab body and a cargo box disposed at a rear portion of the cab body is supported by the chassis frame 12.

The chassis frame 12 includes a pair of side frames 20 and a plurality of cross members 22, 24, 26, 28, 30.

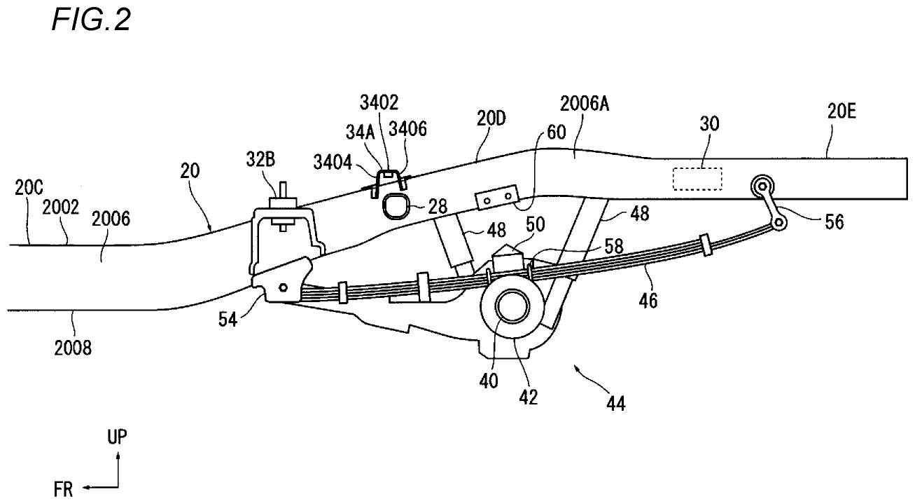

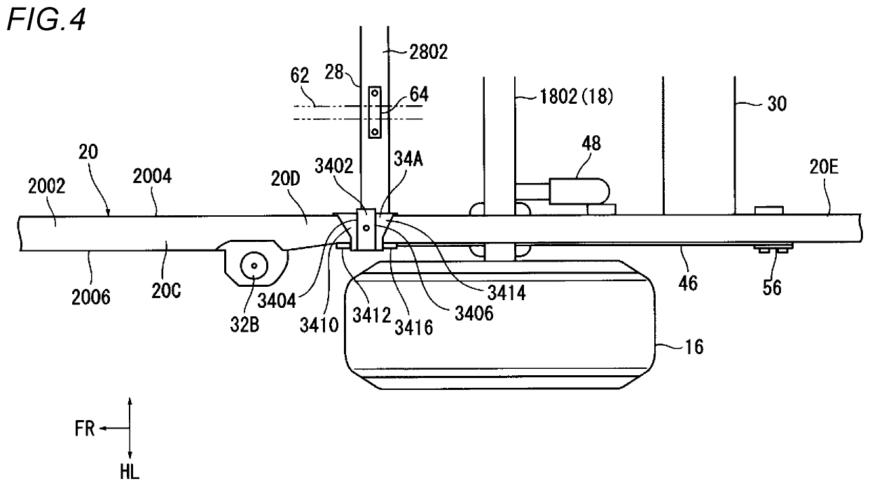

As shown in FIGS. 2 and 4, each of the pair of side frames 20 has a closed cross-sectional structure having a rectangular cross section and includes an upper surface portion 2002, an inner side surface portion 2004, an outer side surface portion 2006, and a lower surface portion 2008, and the pair of side frames 20 are disposed apart in the vehicle width direction and extend in a vehicle front-rear direction.

Each of the pair of side frames 20 includes a front portion 20A extending rearward from a front end of the side frame 20, a front kick-up portion 20B inclined rearward and downward from a rear end of the front portion 20A, a central portion 20C extending rearward from a rear end of the front kick-up portion 20B, a rear kick-up portion 20D extending rearward and upward from a rear end of the central portion 20C, and a rear portion 20E extending rearward from a rear end of the rear kick-up portion 20D.

An engine and a transmission (not shown) and front wheels 14 are disposed between front portions of the pair of side frames 20.

A propeller shaft 36 for transmitting power of the engine from the transmission to rear wheels 16 extends rearward at a central portion between the pair of side frames 20 in the vehicle width direction.

A rear axle housing 18, each of the rear wheels 16, and a fuel tank 38 are disposed between rear portions of the pair of side frames 20.

The rear axle housing 18 accommodates a differential gear to which the propeller shaft 36 is connected, and supports a pair of (axles) axle shafts (not shown) connected to the differential gear and extending in the vehicle width direction, and the rear wheels 16 are mounted on hubs (not shown) provided at both ends of the pair of axle shafts. The rear axle housing 18 is suspended from the chassis frame 12 by a rear suspension device 44 shown in FIG. 2. The rear suspension device 44 is not shown in FIG. 1.

The fuel tank 38 is made of synthetic resin or sheet metal, and has an elongated shape, and is provided between the pair of side frames 20 with a longitudinal direction aligned with the vehicle front-rear direction. Specifically, the fuel tank 38 extends from a rear of the third cross member 26 to a rear of the fourth cross member 28.

A plurality of mounts 32 are provided on the pair of side frames 20, and the cab body (not shown) is supported from below via the mounts 32.

In the present embodiment, the mounts 32 include a pair of first mounts 32A respectively positioned at the front kick-up portions 20B, and a pair of second mounts 32B respectively positioned at the rear kick-up portions 20D.

A plurality of cargo box support brackets 34 are provided at the rear portions of the pair of side frames 20, and the cargo box is supported from below by the cargo box support brackets 34.

In the present embodiment, the cargo box support brackets 34 include a pair of first cargo box support brackets 34A respectively positioned at the rear kick-up portions 20D, and a pair of second cargo box support brackets 34B positioned at the rear portions 20E. The first cargo box support brackets 34A and the second cargo box support brackets 34B are attached to upper portions of the rear kick-up portions 20D and the rear portions 20E.

The first cargo box support brackets 34A will be described in detail later.

As shown in FIG. 2, at the pair of side frames 20, a dimension between the lower surface portion 2008 and the upper surface portion 2002 at the rear kick-up portion 20D gradually decreases toward a rear.

Specifically, at the rear kick-up portion 20D, an inclination of the lower surface portion 2008 of the side frame 20 with respect to the horizontal plane is set larger than an inclination of the upper surface portion 2002.

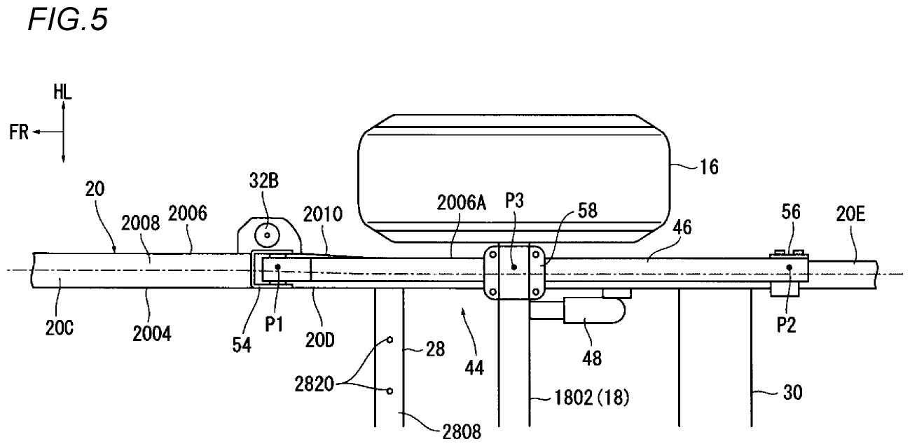

As shown in FIG. 5, in order to avoid interference of the side frame 20 with the rear wheels 16 and vehicle components around the rear wheels 16 disposed outside of the side frames 20 in the vehicle width direction, the outer side surface portion 2006 positioned at a rear portion (the rear kick-up portion 20D and the rear portion 20E in the present embodiment) of the side frame 20 is closer to an inner side in the vehicle width direction than the outer side surface portion 2006 positioned at a front portion of the side frame 20.

Specifically, the outer side surface portion 2006 at the rear portion of the side frame 20 is formed by an inclined surface portion 2010 which is inclined inward in the vehicle width direction toward the rear from a rear end of the outer side surface portion 2006 at the front portion of the side frame 20, and a rear outer side surface portion 2006A (FIG. 2) which extends substantially linearly rearward from a rear end of the inclined surface portion 2010, while the inner side surface portion 2004 at the rear portion of the side frame 20 extends substantially linearly in the vehicle front-rear direction.

In the present embodiment, as shown in FIG. 5, the rear suspension device 44 is of a leaf spring type. A front end of a leaf spring 46 is connected to a rear side from a front end of the rear kick-up portion 20D. A rear end of the leaf spring 46 is connected to the rear portion 20E. A front end of the inclined surface portion 2010 is positioned forward of the front end of the leaf spring 46. The rear end of the inclined surface portion 2010 is positioned forward of a front end of the rear wheel 16. The rear outer side surface portion 2006A extends from a front relative to the front end of the rear wheel 16 to a rear end of the side frame 20.

At least the rear outer side surface portion 2006A may be positioned in a range of the side frame 20 where the rear suspension device 44 is positioned in the vehicle front-rear direction in a plan view to be described later.

As shown in FIG. 1, the plurality of cross members extend in the vehicle width direction at a plurality of positions spaced apart in the vehicle front-rear direction, and connect the pair of side frames 20.

In the present embodiment, the plurality of cross members include five cross members, i.e., first, second, third, fourth, and fifth cross members 22, 24, 26, 28, 30, and are arranged in this order from a front to the rear.

In the present embodiment, the first cross member 22 connects the front portions 20A of the pair of side frames 20.

The second and third cross members 24 and 26 connect the central portions 20C of the pair of side frames 20.

The fourth cross member 28 connects the rear kick-up portions 20D of the pair of side frames 20. In the present embodiment, the fourth cross member 28 corresponds to the “cross member” in the claims, and the rear kick-up portion 20D corresponds to the “kick-up portion” in the claims.

The fifth cross member 30 connects the rear portions 20E of the pair of side frames 20.

Vehicle front ends of the pair of side frames 20 are connected by a bumper beam 31 extending in the vehicle width direction, and a bumper fascia (not shown) is attached to a bumper beam 3134.

As shown in FIG. 2, the rear suspension device 44 suspends the rear axle housing 18 (FIG. 5) with respect to the chassis frame 12 (vehicle body).

In the present embodiment, the rear suspension device 44 includes a pair of leaf springs 46, a pair of shock absorbers 48, and a pair of bump rubbers 50.

The pair of leaf springs 46 are respectively disposed below the pair of side frames 20. Front ends of the pair of leaf springs 46 are supported by lower portions of the rear kick-up portions 20D near the front ends via spring brackets 54. Rear ends of the pair of leaf springs 46 are supported by front portions of the rear portions 20E via shackle links 56.

As shown in FIGS. 2 and 5, intermediate portions of the pair of leaf springs 46 are connected to tubular portions 1802 of the rear axle housing 18 at both sides in the vehicle width direction via connecting tools 58.

As shown in FIG. 2, lower ends of the pair of shock absorbers 48 are connected to the tubular portions 1802 of the rear axle housing 18 positioned inward of the leaf springs 46 in the vehicle width direction.

Upper ends of the pair of shock absorbers 48 are connected to the side frames 20.

As shown in FIG. 2, when an excessive load is input to the rear axle housing 18 and the intermediate portions of the leaf spring 46 are largely bent upward, the pair of bump rubbers 50 abut against lower portions of the side frames 20 to prevent the leaf springs 46 from directly abutting against the lower portions of the side frames 20.

Each of the bump rubbers 50 is attached to a respective one of upper surfaces of the leaf springs 46 and protrudes upward.

A bump bracket 60 against which an upper end of the bump rubber 50 can abut is provided at a lower portion of the rear kick-up portion 20D, and the upper end of the bump rubber 50 stably abuts against a lower portion of the bump bracket 60.

In the rear suspension device 44 as described above, a front end of the rear suspension device 44 is at the front end of the leaf spring 46, i.e., a respective one of spring brackets 54, and a rear end of the rear suspension device 44 is at the rear end of the leaf spring 46, i.e., a respective one of shackle links 56. Thus, in the present embodiment, a range of the side frame 20 where the rear suspension device 44 is positioned in the vehicle front-rear direction in the plan view (a range where the suspension device is positioned in the vehicle front-rear direction in a plan view in the claims) is defined as a range from a position where the spring bracket 54 is provided to a position where the shackle link 56 is provided at the side frame 20.

Here, a load input portion to which a load is input from the rear suspension device 44 to the side frame 20 will be described.

As shown in FIGS. 2 and 5, a load input from the rear wheel 16 via the rear axle housing 18 to the leaf spring 46 from below is input to the side frame 20 via two load input portions P1, P2 at two positions of the spring bracket 54 supporting the front end of the leaf spring 46 and the shackle link 56 supporting the rear end of the leaf spring 46.

As shown in FIG. 5, in the plan view, the load input portions P1, P2 at the two positions are deviated outward in the vehicle width direction from a center of the side frame 20 in a width direction (shown by a dashed line in the drawing).

A load is input to the side frame 20 when the bump rubber 50 abuts against the bump bracket 60, and a load input portion P3 at this time is also deviated outward in the vehicle width direction from the center of the side frame 20 in the width direction, similarly to the two load input portions P1 and P2.

Therefore, the load input to the side frame 20 via the leaf spring 46 and the bump bracket 60 is input to a position deviated outward in the vehicle width direction from a center of a width of the side frame 20 in the vehicle width direction.

Here, a reason why the load input portions P1, P2, P3 are deviated outward in the vehicle width direction from the center of the width of the side frame 20 in the vehicle width direction will be described.

In order to avoid interference between the rear wheel 16 and a vehicle component around the rear wheel 16 and the side frame 20, the rear suspension device 44 is provided at a position where the rear outer side surface portion 2006A of the side frame 20 is positioned, a portion where the leaf spring 46 and the side frame 20 are connected is deviated outward in the vehicle width direction from the center of the width of the side frame 20 in the vehicle width direction, and a center of the bump rubber 50 is deviated outward in the vehicle width direction from the center of the width of the side frame 20 in the vehicle width direction. In other words, the rear suspension device 44 is deviated outward in the vehicle width direction from the center of the width of the side frame 20 in the vehicle width direction.

For this reason, the load input portions P1, P2, P3 are deviated outward in the vehicle width direction from the center of the width of the side frame 20 in the vehicle width direction. Therefore, when a load pushing upward from below is input to the load input portions P1, P2, P3 via the rear suspension device 44, the side frame 20 rotates so that a lower portion of the side frame 20 is twisted outward in the vehicle width direction.

Next, the fourth cross member 28 will be described.

As shown in FIG. 2, the fourth cross member 28 connects an intermediate portion of the rear kick-up portions 20D of the pair of side frames 20 in the vehicle front-rear direction, and both ends of the fourth cross member 28 are joined so as to penetrate through the rear kick-up portions 20D.

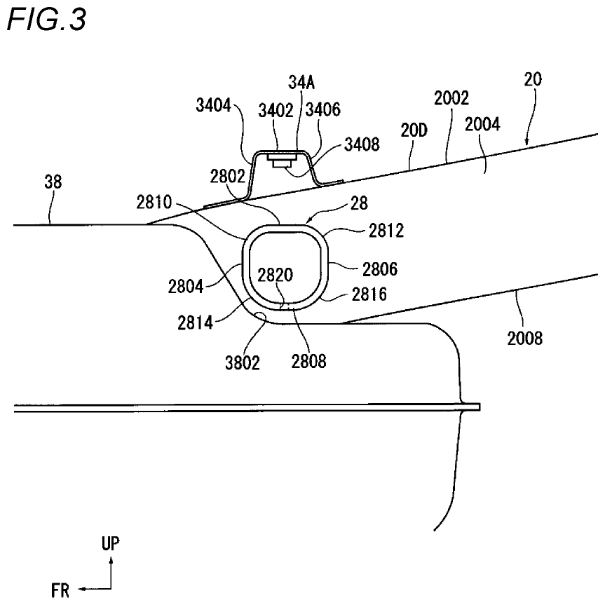

As shown in FIG. 3, the fourth cross member 28 is formed of a pipe having a substantially square cross section with a corner portion curved in an arc shape.

Specifically, the fourth cross member 28 has four flat surface portions including an upper surface portion 2802 facing upward, a front surface portion 2804 facing forward, a rear surface portion 2806 facing rearward, and a lower surface portion 2808 facing downward, and four cylindrical surface portions including a first cylindrical surface portion 2810 connecting the upper surface portion 2802 and the front surface portion 2804, a second cylindrical surface portion 2812 connecting the upper surface portion 2802 and the rear surface portion 2806, a third cylindrical surface portion 2814 connecting the front surface portion 2804 and the lower surface portion 2808, and a fourth cylindrical surface portion 2816 connecting the rear surface portion 2806 and the lower surface portion 2808.

In the present embodiment, the first and second cylindrical surface portions 2810 and 2812 are formed with the same curvature radius RA, the third and fourth cylindrical surface portions 2814 and 2816 are formed with the same curvature radius RB, and the curvature radius RB of the third and fourth cylindrical surface portions 2814 and 2816 is larger than the curvature radius RA of the first and second cylindrical surface portions 2810 and 2812.

In other words, a corner portion of the fourth cross member 28 at a lower side is set to have a curvature radius larger than that of a corner portion at an upper side.

As described above, the fuel tank 38 extends rearward of the fourth cross member 28. As shown in FIG. 3, a rear portion of the fuel tank 38 is formed with a recessed portion 3802 which is recessed downward so as to pass below the fourth cross member 28 (in the present embodiment, a height of an upper surface from a position of the fuel tank 38 in front of the fourth cross member 28 to a rear end is lower than the other positions), and a front end portion of the recessed portion 3802 is curved along the third cylindrical surface portion 2814.

Although a volume of the fuel tank 38 is reduced by forming the recessed portion 3802, the curvature radius RB of the third cylindrical surface portion 2814 is large, which is advantageous in securing the volume of the fuel tank 38 compared with a case where the curvature radius of the third cylindrical surface portion 2814 is small.

When the fuel tank 38 is expanded, a load is applied to the corner portion of the fuel tank 38, and at this time, the load is similarly applied to a curve at a front end of the recessed portion 3802. Since the curvature radius RB of the corner portion (third cylindrical surface portion 2814) of the fourth cross member 28 at the lower side is large, a curvature radius of the curve at the front end of the recessed portion 3802 can also be made large, and concentration of the load can be prevented.

As shown in FIGS. 2 and 5, the fourth cross member 28 is positioned within a range where the rear suspension device 44 is positioned in the vehicle front-rear direction in the plan view.

Therefore, a load pushing up from the rear suspension device 44 to an upper side is easily input to the fourth cross member 28 via the side frame 20.

As shown in FIGS. 3 and 5, a plurality of drain holes 2820 are formed in the lower surface portion 2808 of the fourth cross member 28 spaced in the vehicle width direction along a center line of the lower surface portion 2808 in the vehicle front-rear direction.

As shown in FIG. 4, a cable 62 of an in-vehicle equipment extending in a direction intersecting an extending direction of the fourth cross member 28 is placed at the upper surface portion 2802 of the fourth cross member 28, and the cable 62 is attached to the upper surface portion 2802 of the fourth cross member 28 via an attachment 64 such as a clamp.

As shown in FIG. 1, at the rear kick-up portion 20D, the above first cargo box support bracket 34A is attached to a position above a connecting portion to which the fourth cross member 28 is connected. The first cargo box support bracket 34A may correspond to the “brackets” in the claims.

As shown in FIGS. 2 to 4, the first cargo box support bracket 34A includes an attachment surface portion 3402, a front surface portion 3404, and a rear surface portion 3406.

The front surface portion 3404 and the rear surface portion 3406 extend in a vehicle upper-lower direction and are connected to the upper surface portion 2002 at the rear kick-up portion 20D. Outer side end portions of the front surface portion 3404 and the rear surface portion 3406 in the vehicle width direction extend below the upper surface portion 2002 at the rear kick-up portion 20D and are connected to the outer side surface portion 2006 at the rear kick-up portion 20D.

In the present embodiment, a lower end portion of the front surface portion 3404 is positioned in front of the first cylindrical surface portion 2810 of the fourth cross member 28, a lower end portion of the rear surface portion 3406 is positioned above the second cylindrical surface portion 2812 of the fourth cross member 28, and each of the lower end portions is connected to the rear kick-up portion 20D in the vicinity of the fourth cross member 28.

The attachment surface portion 3402 extends to connect the front surface portion 3404 and the rear surface portion 3406.

The attachment surface portion 3402 is provided with a weld nut 3408 (FIG. 3) to which a bolt inserted through a cargo box is fastened at the central portion 20C thereof.

Next, functions and effects will be described.

According to the present embodiment, the fourth cross member 28 which connects the pair of side frames 20 is formed by a pipe having a substantially square shape in a cross section with the corner portion curved in an arc shape, and the corner portion of the fourth cross member 28 at the vehicle lower side is set to have the curvature radius RB larger than that of the corner portion at the vehicle upper side.

Since the fourth cross member 28 is formed in a substantially square shape in the cross section, it is possible to increase a cross-sectional area of the fourth cross member 28 while preventing an increase in diameter (distance between opposing surfaces), as compared with a case where the cross section is circular, which is advantageous in improving torsional rigidity of the fourth cross member 28 without securing a large occupied space.

Since the corner portion of the fourth cross member 28 at the vehicle lower side is set to have the curvature radius RB larger than that of the corner portion at the vehicle upper side, when a load input to the side frame 20 so as to push upward from below is applied to a joint portion between the side frame 20 and the fourth cross member 28, it is possible to prevent the load from concentrating on the corner portion of the fourth cross member 28 at the vehicle lower side, which is advantageous in securing durability of joint portions between the fourth cross member 28 and the pair of side frames 20.

Therefore, it is advantageous in securing torsional rigidity of the fourth cross member 28 and durability of the joint portions with the pair of side frames 20.

Although various peripheral devices are disposed below the fourth cross member 28, the corner portion of the fourth cross member 28 at the vehicle lower side is set to have the curvature radius RB larger than that of the corner portion at the vehicle upper side, which is advantageous in securing a gap between the fourth cross member 28 and a peripheral device disposed below the fourth cross member 28.

In the present embodiment, the pair of side frames 20 includes the rear kick-up portions 20D which are inclined upward toward the rear, and the fourth cross member 28 is connected to the rear kick-up portions 20D.

Since the rear kick-up portion 20D is inclined, when a load is input from below, an end portion of the rear kick-up portion 20D is easily deformed to rotate in the upper-lower direction. In the present embodiment, a center of the load input portions (a midpoint of a line connecting P1 and P2) for a load inputting from below to the pair of side frames 20 is positioned at a rear portion of the rear kick-up portion 20D, so that the rear end of the rear kick-up portion 20D is easily deformed so as to rotate upward. Therefore, a load is easily input to the fourth cross member 28 connected to the rear kick-up portion 20D.

According to the present embodiment, since torsional rigidity of the fourth cross member 28 and durability of the joint portions with the pair of side frames 20 are advantageously secured, the cross member is advantageously connected to the rear kick-up portion 20D.

In the present embodiment, the upper surface portion 2802 and the lower surface portion 2808 of the fourth cross member 28 extend in a horizontal direction, and the lower surface portion 2008 at the rear kick-up portion 20D is inclined upward toward the rear. Therefore, a dimension between a corner portion of the fourth cross member 28 at a lower side and a rear side and a lower side ridgeline of the rear kick-up portion 20D is short, and a load input to the side frame 20 from below is likely to concentrate on the corner portion of the fourth cross member 28 at the vehicle lower side and a vehicle rear side from the lower side ridgeline of the rear kick-up portion 20D. In particular, in the present embodiment, since an inclination of the lower surface portion 2008 of the rear kick-up portion 20D is set to be larger than an inclination of the upper surface portion 2002, a dimension between the corner portion of the fourth cross member 28 at the lower side and the rear side and the lower side ridgeline of the rear kick-up portion 20D is shorter than a dimension between a corner portion of the fourth cross member 28 at an upper side and a front side and an upper side ridgeline of the rear kick-up portion 20D.

In the present embodiment, since the corner portion of the fourth cross member 28 at the lower side and the rear side is set to have the curvature radius RB larger than that of the corner portion at the upper side, a large dimension can be secured between the corner portion of the fourth cross member 28 at the lower side and the rear side and the lower side ridgeline of the rear kick-up portion 20D, which is advantageous in preventing concentration of a load applied from the lower side ridgeline of the rear kick-up portion 20D to the corner portion of the fourth cross member 28 at the vehicle lower side and the vehicle rear side, and is more advantageous in securing durability of the joint portions between the fourth cross member 28 and the pair of side frames 20.

In the present embodiment, the rear suspension device 44 is connected to the lower portions of the pair of side frames 20, and the fourth cross member 28 is positioned within the range where the rear suspension device 44 is positioned in the vehicle front-rear direction in the plan view.

Since a load input so as to push up from the rear suspension device 44 via the side frame 20 to the upper side is easily transmitted to the fourth cross member 28, a larger load is input to the joint portions between the fourth cross member 28 and the pair of side frames 20.

According to the present embodiment, since the corner portion of the fourth cross member 28 at the lower side is set to have the curvature radius RB larger than that of the corner portion at the upper side, even when a large load is input to the joint portions between the fourth cross member 28 and the pair of side frames 20, it is possible to prevent the load from concentrating on the corner portion of the fourth cross member 28 at the vehicle lower side, which is advantageous in securing durability of the joint portions between the fourth cross member 28 and the pair of side frames 20.

In the present embodiment, the rear suspension device 44 is deviated outward from the center of the side frame 20 in the vehicle width direction.

Therefore, when a load is input from the rear suspension device 44 to the upper side with respect to the side frame 20 so as to push upward, the side frame 20 is twisted such that the lower portion of the side frame 20 rotates outward in the vehicle width direction. Accordingly, the load is intensively applied to the corner portion of the fourth cross member 28 at the vehicle lower side.

In the present embodiment, since the corner portion of the fourth cross member 28 at the vehicle lower side is set to have the curvature radius RB larger than that of the corner portion at the vehicle upper side, it is possible to prevent the load from concentrating on the corner portion of the fourth cross member 28 at the vehicle lower side.

The first cargo box support bracket 34A is attached to a position of the side frame 20 above the fourth cross member 28, and a vicinity of an upper portion of the joint portion between the fourth cross member 28 and the side frame 20 is reinforced by the first cargo box support bracket 34A.

Therefore, strength and rigidity of the joint portions between the fourth cross member 28 and the pair of side frames 20 are secured, which is advantageous in securing durability when a load concentrates on the corner portion of the fourth cross member 28 at the vehicle upper side.

By using the first cargo box support bracket 34A, there is no need to provide a dedicated reinforcing member, which is advantageous in reducing the number of components, reducing cost of components, and reducing a weight.

In the present embodiment, since the drain holes 2820 are formed in the lower surface portion 2808 of the fourth cross member 28, water, mud, or the like entering an inside of the fourth cross member 28 is easily guided to the drain holes 2820 along the arc shape of the corner portion of the fourth cross member 28 at the vehicle lower side, and water, mud, or the like can be smoothly discharged downward from the lower surface portion 2808.

In the present embodiment, since the curvature radius RA of the arc shape of the corner portion of the fourth cross member 28 at the vehicle upper side is set to be small, it is possible to secure a large area of the upper surface portion 2802 of the fourth cross member 28.

Therefore, it is easy to directly attach the cable 62 of the in-vehicle equipment to the upper surface portion 2802, and it is not necessary to provide a dedicated bracket for attaching the cable 62 of the in-vehicle equipment to the fourth cross member 28, which is advantageous in reducing the number of components and the cost of the components.

In the present embodiment, a case where the chassis frame 12 includes the five cross members including the first to fifth cross members 22, 24, 26, 28, and 30 has been described, but the number of cross members is freely provided, and to which cross member the present invention is applied is freely performed.

In the present embodiment, a case where the cross member (the fourth cross member 28) connects the rear kick-up portions 20D of the pair of side frames 20 has been described, but the cross member may connect the front kick-up portions 20B of the pair of side frames 20.

In the present embodiment, a case where the suspension device is a leaf spring type has been described, but the suspension device may be a coil spring type or the like. In a case where the suspension device is of a coil spring type, a range where the suspension device is positioned in the vehicle front-rear direction in the plan view is a range from a portion of the side frame facing the foremost position of a component constituting the suspension device to a portion of the side frame facing the rearmost position, such as a range from a connection part of a lower arm in the side frame to a connection part of the shock absorber.

In the present embodiment, a case where the bracket which is attached to an upper portion of the side frame 20 above the fourth cross member 28 is the first cargo box support bracket 34A is described, but use of the bracket is not limited.

The present application is based on Japanese patent application No. 2021-056536 filed on Mar. 30, 2021, and contents thereof are incorporated herein as reference.

### REFERENCE SIGNS LIST

10: frame vehicle
12: chassis frame
14: front wheel
16: rear wheel
18: rear axle housing
1802: tubular portion
20: side frame
20A: front portion
20B: front kick-up portion
20C: central portion
20D: rear kick-up portion (kick-up portion)
20E: rear portion
2002: upper surface portion
2004: inner side surface portion
2006: outer side surface portion
2006A: rear outer side surface portion
2008: lower surface portion
2010: inclined surface portion
22: first cross member
24: second cross member
26: third cross member
28: fourth cross member (cross member)
2802: upper surface portion
2804: front surface portion
2806: rear surface portion
2808: lower surface portion
2810: first cylindrical surface portion
2812: second cylindrical surface portion
2814: third cylindrical surface portion
2816: fourth cylindrical surface portion
2820: drain hole
30: fifth cross member
31: bumper beam
32: mount
32A: first mount
32B: second mount
34: cargo box support bracket
34A: first cargo box support bracket
3402: attachment surface portion
3404: front surface portion
3406: rear surface portion
3408: weld nut
34B: second cargo box support bracket
36: propeller shaft
38: fuel tank
3802: recessed portion
44: rear suspension device
46: leaf spring
48: shock absorber
50: bump rubber
54: spring bracket
56: shackle link
58: connecting tool
60: bump bracket
62: cable
64: attachment
P1, P2, P3: load input portion

1. A vehicle structure comprising:
a pair of side frames disposed apart in a vehicle width direction and extending in a vehicle front-rear direction; and
a cross member extending in the vehicle width direction and provided to penetrate the pair of side frames, the cross member connecting the pair of side frames, wherein
the cross member is formed of a pipe having a substantially square cross section with a corner portion curved in an arc shape,
the corner portion of the cross member at a vehicle lower side is set to have a curvature radius larger than a curvature radius of the corner portion at a vehicle upper side, and
at positions where the side frames and the cross member are overlapped with each other in an upper-lower direction, the brackets that support an object are provided at the positions of the side frames above the cross member.

2. The vehicle structure according to claim 1, wherein
the pair of side frames have kick-up portions inclined toward one side in the upper-lower direction as the kick-up portions extend toward one side in the vehicle front-rear direction, and
the cross member connects between the kick-up portions of the pair of side frames.

3. The vehicle structure according to claim 1, wherein
a suspension device is provided at lower portions of the pair of side frames, and
the cross member is positioned within a range in which the suspension device is positioned in the vehicle front-rear direction in a plan view.

4. The vehicle structure according to claim 3, wherein
a load input portion from the suspension device to each of the side frames is deviated outward in the vehicle width direction relative to a center of a width of the side frames in the vehicle width direction.

5. (canceled)

6. The vehicle structure according to claim 1, wherein
a drain hole is formed in a lower surface of the cross member.

7. The vehicle structure according to claim 1, wherein
a cable of an in-vehicle equipment is fixed to an upper surface of the cross member.
